(19) United States
(12) Patent Application Publication
(10) Pub. No.: US 2006/0251496 A1
(43) Pub. Date: Nov. 9, 2006

(54) Fastener arrangement for fastening a detachable panel

(75) Inventors: Christopher Neil Wood, Woodford Cheshire (GB); Philip Ian Robinson, Woodford Cheshire (GB); Howard Raymond Apps, Woodford Chesire (GB)

Correspondence Address: CROWELL & MORING LLP;INTELLECTUAL PROPERTY GROUP, P.O. BOX 14300, WASHINGTON, DC, 20044-4300, US

(73) Assignee: BAE SYSTEMS plc, London (GB)

(21) Appl. No.: 10/542,961

(22) PCT Filed: Jul. 5, 2005
(86) PCT No.: PCT/GB05/50102

§ 371 Date: Jul. 21, 2005

(30) Foreign Application Priority Data
Jul. 9, 2004 (EP) 04254144.1
Jul. 9, 2004 (GB) 0415399.5

(51) Int. Cl. B64C 1/12; F16D 1/00; F16B 19/06

(52) U.S. Cl. 411/507; 244/132; 403/408.1

(57) ABSTRACT

In one embodiment the fastening of a detachable panel can be seen in, an assembly comprising a fastener 28, a panel 10 and a supporting structure 12. The panel 10 and a flange 14 of the supporting structure 12 are formed with respective tapered holes 22,24 which receive the fastener 28, the taper of one hole being a continuation of the taper of the other. The fastener 28 is secured to the flange 12 and urges a tapered surface 32 of the fastener 28 into the tapered holes 22, 24 in a non-jamming manner thereby locating the panel 10 with respect to the flange 12 and hence with respect to the supporting structure 14.

The invention relates to fastening a detachable panel and is particularly, but not exclusively, concerned with the fastening of a detachable load bearing panel to the supporting structure of an aircraft.

Panels on an aircraft, such as engine cover panels, need to be detached at times for access to working parts of the aircraft. Large panels can often be fastened down by a multiplicity of fasteners. Whilst removal of the fasteners for detachment of the panel is usually not too difficult, re-alignment of the panel, during re-fitting, to clear the fasteners protruding from the supporting structure can sometimes be a problem where large numbers of fasteners are involved.

It is known to attach a panel to an aircraft structure using a multiplicity of fasteners, e.g. studs attached to the structure and which project out of the structure for location in fixing holes in the panel. Once located in the panel, nuts are screwed on to the studs to hold the panel in place. Detachment of the panel is not difficult with such an arrangement but re-location of the panel can be difficult as it is necessary to align the studs with the large number of holes in the panel. Another problem with such an arrangement can arise during the initial installation of the studs where it is necessary to ensure that all the studs are precisely parallel with each other. This can be quite difficult to achieve where the panel and structure have compound curvatures, and can require the use of expensive tooling to ensure that the studs are installed correctly.

An object of the present invention is to provide a fastening which will help to overcome the problems outlined in the immediately preceding paragraph and which may also be useful in other applications where detachable fastening of panels is involved.

According to a first aspect of the invention there is provided an assembly comprising a fastener, a panel and a supporting structure to which the panel is detachably fastened by the fastener, the panel and supporting structure being formed with tapered holes which receive the fastener, the taper of one hole being a continuation of the taper of the other, and the fastener urging a tapered surface into the tapered holes in a non-jamming manner thereby locating the panel with respect to the supporting structure.

This arrangement provides advantages over the prior art in respect of maintaining a shear load path through the panel and the fastener which deviates from the plane of the panel by a lesser amount. A second advantage is that the joint can be disassembled more easily because the interference fit of the prior art taper is avoided.

Where the panel of the assembly needs to be held in place by a multiplicity of fasteners, the fasteners can be located one at a time in such an assembly making it unnecessary to align a multiplicity of bolts on the structure with holes in the panel. At the same time, the tapers ensure accurate location of the panel with respect to the mounting structure.

For aerodynamic surfaces, for example, the fastener is positioned in the holes so as not to project beyond an outer surface of the panel. Such positioning of the fastener means that it will not interfere with air flow over the panel.

In one embodiment, the tapered surface may be formed on the fastener itself.

In another embodiment, the tapered surface may be formed on a separate element which locates in the tapered holes and through which the fastener passes to hold the element in place.

According to a second aspect of the invention there is provided a fastener for fastening a detachable panel to a supporting structure, the panel and supporting structure being formed with tapered holes which receive the fastener, the taper of one hole being a continuation of the taper in the other, the fastener comprising a body having a tapered outer surface which, in use, locates in the tapered holes in a non-jamming manner and thereby positions the panel with respect to the supporting structure.

The taper on the fastener is of a non-jamming type, for example having a taper angle greater than around 50 degrees. By selecting a non jamming taper angle, it is possible to rotate the fastener in the hole to secure it in position. For example, the fastener may have a screw threaded end which screws into a nut, such as an anchor nut, on the supporting structure.

According to a third aspect of the invention there is provided a fastening means for fastening a detachable panel to a supporting structure, the fastening means comprising a tapered element and a fastener, the panel and supporting structure being formed with tapered holes which receive the tapered element and the fastener, the taper of one hole being a continuation of the taper in the other, the tapered element comprising a body having a tapered outer surface and having a bore through which the fastener can be passed to secure the tapered element in the tapered holes and thereby position the panel with respect to the supporting structure.

Where a tapered element of the kind set out in the immediately preceding paragraph is used, the fastener preferably takes the form of a simple bolt which passes through the tapered element leading to a reduction in the cost of the fastener.

The tapered element may be of frusto-conical form.

Fastening of detachable panels will now be described by way of example with reference to the accompanying drawings in which:

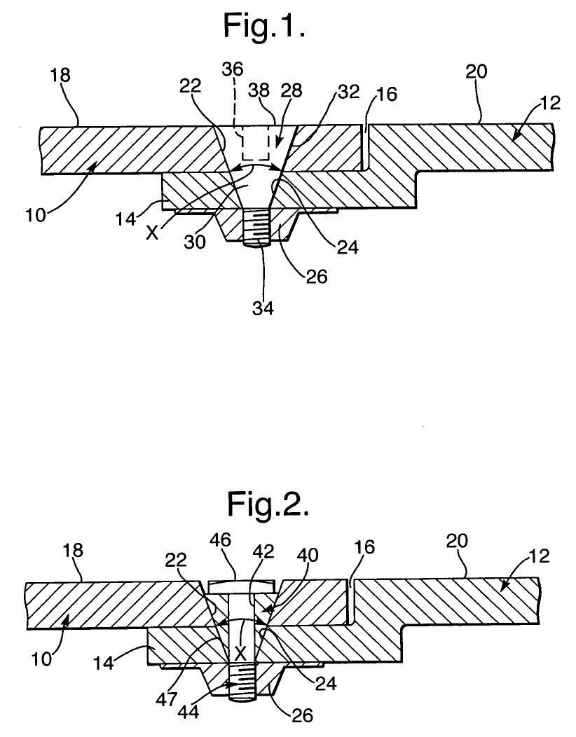

FIG. 1 is a cross-section through a panel and supporting structure illustrating one form of fastening using a fastener having a tapered surface and

FIG. 2 is a cross-section through a panel and supporting structure illustrating another form of fastening using a tapered element and a fastener of standard kind.

Looking at FIG. 1, a panel 10 is fastened to a supporting structure 12 which in the embodiment illustrated has a stepped-down flange 14 which creates a recess 16. The recess 16 receives the panel 10 so that an outer surface 18 of the panel lies flush with an adjacent outer surface 20 of the supporting structure 12.

With the panel 10 held against the flange 14, a drill bit is used to drill straight through the panel 10 and flange 14 to enable a taper cutting tool (not shown) of known kind to be inserted. The taper cutting tool is then used to produce respective tapered holes 22, 24 in the panel 10 and flange 14 simultaneously from the straight drilling. An adjustable depth control surrounds the taper cutting tool and is adjusted to ensure the correct depth of cut. It will be seen clearly in FIG. 1 that the taper of the hole 24 forms a continuation of the taper of the hole 22. It will also be seen in FIG. 1 that hole 24 is tapered for its full depth. Although a full depth taper is preferred, the hole 24 could be tapered for, say, two thirds of its depth leaving the remainder of the hole in its straight drilled form. A floating anchor nut 26 of known kind is fastened to the underside of the flange 14 in alignment with the hole 24. Several such holes 22, 24 are formed in the panel 10 and flange 14 at spaced apart positions.

A fastener 28 has a body 30 formed with a tapered outer surface 32. The angle of taper X of the body 30 corresponds to the angle of taper of the holes 22, 24. The body 30 is formed with a screw-threaded lower end 34 as viewed in FIG. 1 which screws into the anchor nut 24 and has a recess 36 in a flat upper end 38 suitable for receiving a torque applying tool (not shown). It will be noted from FIG. 1 that the tapered part of the fastener body 30 has an axial length substantially equal to the combined thicknesses of the panel 10 and flange 14. The torque applying tool is used to turn the fastener 28 in the holes 22, 24 so that the screw-threaded lower end 34 screws into the anchor nut 26. Turning is continued until the tapered outer surface 32 of the fastener 28 is driven firmly into contact with the walls of tapered holes 22, 24. At that point, the flat upper end 38 of the fastener 28 will lie flush with the surrounding outer surface 18 of the panel 10. By ensuring that the upper end 38 of the fastener does not project above the surface 18, it will not interfere with air flow over the surface 18 where the panel 10 forms part of an aircraft outer skin. The location of the tapered fastener 28 in the tapered holes 22, 24 ensures that the panel 10 will be located accurately in relation to the flange 14. Further fasteners 28 are screwed in remaining holes to fasten the panel 10 in place.

As the fastener 28 has to be rotated in the holes 22, 24 to screw it into position, the angle of taper X is selected so as to be non-jamming. A typical example of a jamming taper is a Morse taper drill where the taper permits the drill to be driven by friction. In the present invention, the angle of taper X must not be too small so as to produce a jamming effect which would prevent rotation of the fastener 28. On the other hand, the angle of taper X must not be so great that accurate positioning of the panel 10 relative to the flange 14 will be impaired. With that in mind, we use an angle X in the range of 50 to 450 degrees and have found an angle of approximately 300 degrees to be particularly suitable. The angle X chosen will of course be partly dependent on the materials chosen as the frictional characteristics operating between different materials will vary.

The angle chosen will alter the shear and clamping qualities of the joint. If a larger angle is chosen the clamping effect will be enhanced but the ability to transfer shear load will be reduced. If a smaller angle is chosen the shear load transfer quality of the joint will be enhanced but the clamping will be reduced. If too great an angle is selected a phenomenon known as “edge distress” may occur. With such a design the outer edge region of the fastener may become unacceptably thin and subject to distortion.

To detach the panel 10 from the supporting structure 12, the fasteners 28 are unscrewed from the anchor nuts 26 and simply lifted out of the holes 22, 24. The panel 10 can then be lifted off the flange 14.

Looking next at FIG. 2, parts corresponding to parts shown in FIG. 1 carry the same reference numerals and only the differences will be described.

Instead of using a specially manufactured tapered screw threaded fastener, the embodiment in FIG. 2 uses a frusto-conical element 40 having a coaxial hole 42 through which a standard bolt 44 passes. The element 40 has an outer surface 47 tapered to correspond with the angle of taper of the holes 22, 24 and preferably tapers substantially to nothing at its lower end as viewed in FIG. 2. The length of the tapered element 40 is such as to enable the top of a head 46 of the bolt 44 to lie flush with the surface 18 of the panel. Where the panel 10 forms part of an aircraft outer skin, filler (not shown) may be used to fill the space between the bolt head 46 and the adjacent wall of hole 22. The angle of taper X is preferably selected in FIG. 2 to be non-jamming so that the tapered element 40 can easily be removed from the holes 22, 24 when the panel 10 is to be detached. However, it will be appreciated that it is not necessary to facilitate rotation of the tapered element 40 in the holes 22, 24 when fastening it into position.

The use of the tapered fastener 28 or the tapered element 40 provides a good shear resistant connection between the panel 10 and the supporting structure 12 as well as good clamping. It is not necessary to produce a recess in the outer surface of the panel specifically to receive a nut as is the case with the upstanding bolt arrangement referred to in the introduction. Moreover parallelism is not a critical issue as the fasteners can simply be inserted one at a time and, therefore, it is not necessary to align a large number of holes in a panel with permanently fixed fasteners. A more direct load path is also provided by the present invention compared to that provided by the upstanding bolt arrangement owing to the overall “depth” of the joint being lower, which reduces the out of plane deflection of the load path.

1. An assembly comprising a fastener, a panel and a supporting structure to which the panel is detachably fastened by the fastener, the panel and supporting structure being formed with tapered holes which receive the fastener, the taper of one hole being a continuation of the taper of the other, and the fastener urging a tapered surface into the tapered holes in a non-jamming manner thereby locating the panel with respect to the supporting structure.

2. An assembly according to claim 1 in which the fastener is positioned in the holes so as not to project beyond an external surface of the panel.

3. An assembly according to claim 1 in which the tapered surface is formed on the fastener itself.

4. An assembly according to claim 1 in which the tapered surface is formed on an element located in the tapered holes, and the fastener passing through the element to hold the element in place.

5. An assembly according to claim 4 in which the element is of frusto-conical form.

6. An assembly according to claim 1 in which the angle of taper of the holes and the angle of taper of the said tapered surface are the same.

7. An assembly according to claim 1 in which the angle of taper of the said tapered surface is in the range of 5° to 45° degrees.

8. An assembly according to claim 7 in which the angle of taper is substantially 30 degrees.

9. (canceled)

10. A fastener for fastening a detachable panel to a supporting structure, the panel and supporting structure being formed with tapered holes which receive the fastener, the taper of one hole being a continuation of the taper in the other, the fastener comprising a body having a tapered outer surface which is arranged to locate in the tapered holes in a non-jamming manner and thereby position the panel with respect to the supporting structure.

11. (canceled)

12. An fastening means for fastening a detachable panel to a supporting structure, the fastening means comprising a tapered element and a fastener, the panel and supporting structure being formed with tapered holes which receive the tapered element and the fastener, the taper of one hole being a continuation of the taper in the other, the tapered element comprising a body having a tapered outer surface and having a bore through which the fastener can be passed to secure the tapered element in the tapered holes and thereby position the panel with respect to the supporting structure.

13. (canceled)
